(19) United States
(12) Patent Application Publication
(10) Pub. No.: US 2026/0095283 A1
(43) Pub. Date: Apr. 2, 2026

(54) SOUNDING REFERENCE SIGNAL PORT GROUPING

(71) Applicant: InterDigital Patent Holdings, Inc., Wilmington, DE (US)

(72) Inventors: Afshin Haghighat, Ile-Bizard (CA); Mohammad Irfan, Chateauguay (CA); Loic Canonne-Velasquez, Dorval (CA); Jonghyun Park, Syosset, NY (US); Omid Saatlou, Montreal (CA); Virgil Comsa, Montreal (CA); Moon IL Lee, Melville, NY (US)

(73) Assignee: InterDigital Patent Holdings, Inc., Wilmington, DE (US)

(21) Appl. No.: 18/899,952

(22) Filed: Sep. 27, 2024

(51) Int. Cl. H04L 5/00; H04W 72/51

(52) U.S. Cl. CPC H04L 5/0048; H04L 5/0053; H04L 5/0096; H04W 72/51

(57) ABSTRACT

Receivers, such as low-complexity receivers, in a wireless/transmit receive unit (WTRU) are enabled to efficiently transmit, receive, and process signals via sounding reference signal (SRS) port-groups. The WTRU announces its capabilities regarding SRS port-groups to a network. The WTRU receives configuration information associating the WTRU's antennas to SRS port-groups, wherein subsets of the WTRU's antennas are respectively associated with SRS port-groups. The WTRU transmits, receives, and process signals in accordance with the antenna/SRS port-group associations.

### BACKGROUND

Low complexity receivers are extensively used in cellular communications systems. In new radio (NR), reception, detection, demodulation, and decoding of downlink information, such as codewords for example, is a relatively complex and power-hungry process.

### SUMMARY

Described herein are mechanisms, apparatuses, procedures, and methods for enabling low-cost receivers to receive, detect, demodulate, and decode downlink information. Various forms of sounding reference signal (SRS) grouping are described to process reciprocity-based downlink transmissions, also known as non-codebook-based transmissions, and codebook-based downlink transmissions. The definition and management of SRS port-groups to enable efficient operation of low-cost received are described. Mechanisms for associating SRS port-groups and downlink channel state information (CSI) are described. Mechanisms for determining a receiver (Rx) port-group for reception of a codeword in a single codeword transmission are described. Mechanisms for determining Rx port-group(s) for reception of each codeword in a multiple codeword (e.g., two codeword) transmission are described. Mechanisms for determining power for SRS transmissions from each SRS port-group are described.

Receivers, such as low-complexity receivers, in a wireless/transmit receive unit (WTRU) are enabled to efficiently transmit, receive, and process signals via sounding reference signal (SRS) port-groups. The WTRU announces its capabilities regarding SRS port-groups to a network. The WTRU receives configuration information associating the WTRU's antennas to SRS port-groups, wherein subsets of the WTRU's antennas are respectively associated with SRS port-groups. The WTRU transmits, receives, and process signals in accordance with the antenna/SRS port-group associations.

An example WTRU for facilitating SRS port grouping may comprise a transceiver and a processor. The processor may be configured to send capability information indicating a capability of the WTRU to support sounding reference signal (SRS) port-grouping, wherein a first SRS port-group comprises a first number of SRS ports and a second SRS port-group comprises a second number of SRS ports. The processor may be configured to receive configuration information, wherein the configuration information may comprise an indication for the WTRU to support uplink (UL) transmission via the first SRS port-group in accordance with the first number of SRS ports and a second SRS port-group in accordance with the second number of SRS ports, wherein the first SRS port-group may comprise an association of a first subset of antennas for transmission of the first set of SRS ports and the second SRS port-group may comprise an association of a second subset of antennas for transmission of the second set of SRS ports. The processor may be configured to transmit, via the transceiver, the first set of SRS ports via the first SRS port-group. The processor may be configured to transmit, via the transceiver, the second set of SRS ports via the second SRS port-group. The capability information may comprise an indication that the WTRU is capable of jointly processing a received signal via all antennas associated with the first SRS port-group and the second SRS port-group. The capability information may comprise an indication that the WTRU is capable of independently processing the received signal via the first subset of antennas associated with the first SRS port-group and independently processing the received signal via the second subset of antennas associated with the second SRS port-group. The capability information may comprise an indication that the WTRU is capable of jointly processing a received signal via all antennas associated with the first SRS port-group and the second SRS port-group, and that the WTRU is capable of independently processing the received signal via the first subset of antennas associated with the first SRS port-group and independently processing the received signal via the second subset of antennas associated with the second SRS port-group. The capability information may comprise an indication of a maximum number of SRS port-group supportable by the WTRU. First downlink (DL) channel state information (CSI) may be associated with the first SRS port-group. Second DL CSI may be associated with the second SRS port-group. The processor may be configured to receive, via the transceiver, a DL scheduling grant, wherein the DL scheduling grant may comprise an indication for the WTRU to support a DL reception via the first subset of antennas associated with the first SRS port-group or support DL reception via the second subset of antennas associated with the second SRS port-group. The configuration information may comprise a first transmission configuration indicator (TCI) indicative of processing a first codeword via the first subset of antennas associated with the first SRS port-group and a second TCI indicative of processing a second codeword via the second subset of antennas associated with the second SRS port-group. The processor may be configured to process a first codeword via the first subset of antennas associated with the first SRS port-group, and process a second codeword via the second subset of antennas associated the second SRS port-group. SRS port grouping may be capable of being dynamically activated or deactivated via the DL scheduling grant. The processor may be configured to receive a DL reference signal for pathloss estimation, and determine a pathloss associated with the first subset of antennas associated with the first SRS port-group and the second subset of antennas associated with the second SRS port-group. The processor may be configured to send, via the transceiver, a first power headroom report (PHR) for the first SRS port-group, and send, via the transceiver, a second PHR for the second SRS port-group.

An example method for facilitating SRS port groups may be performed by a WTRU. The method may comprise sending capability information indicating a capability of the WTRU to support sounding reference signal (SRS) port-grouping, wherein a first SRS port-group comprises a first number of SRS ports and a second SRS port-group comprises a second number of SRS ports. The method may comprise receiving configuration information, wherein the configuration information may comprise an indication for the WTRU to support uplink (UL) transmission via the first SRS port-group in accordance with the first number of SRS ports and a second SRS port-group in accordance with the second number of SRS ports, wherein the first SRS port-group may comprise an association of a first subset of antennas for transmission of the first set of SRS ports and the second SRS port-group may comprise an association of a second subset of antennas for transmission of the second set of SRS ports. The method may comprise transmitting the first set of SRS ports via the first SRS port-group. The method may comprise transmitting the second set of SRS ports via the second SRS port-group. The capability information may comprise an indication that the WTRU is capable of jointly processing a received signal via all antennas associated with the first SRS port-group and the second SRS port-group. The capability information may comprise an indication that the WTRU is capable of independently processing the received signal via the first subset of antennas associated with the first SRS port-group and independently processing the received signal via the second subset of antennas associated with the second SRS port-group. The capability information may comprise an indication that the WTRU is capable of jointly processing a received signal via all antennas associated with the first SRS port-group and the second SRS port-group, and that the WTRU is capable of independently processing the received signal via the first subset of antennas associated with the first SRS port-group and independently processing the received signal via the second subset of antennas associated with the second SRS port-group. The capability information may comprise an indication of a maximum number of SRS port-group supportable by the WTRU. First DL channel state information (CSI) may be associated with the first SRS port-group. Second DL CSI may be associated with the second SRS port-group. The method may comprise receiving a DL scheduling grant, wherein the DL scheduling grant may comprise an indication for the WTRU to support a DL reception via the first subset of antennas associated with the first SRS port-group or support DL reception via the second subset of antennas associated with the second SRS port-group. The configuration information may comprise a first transmission configuration indicator (TCI) indicative of processing a first codeword via the first subset of antennas associated with the first SRS port-group and a second TCI indicative of processing a second codeword via the second subset of antennas associated with the second SRS port-group. The method may comprise processing a first codeword via the first subset of antennas associated with the first SRS port-group, and processing a second codeword via the second subset of antennas associated the second SRS port-group. SRS port grouping may be capable of being dynamically activated or deactivated via the DL scheduling grant. The method may comprise receiving a DL reference signal for pathloss estimation, and determining a pathloss associated with the first subset of antennas associated with the first SRS port-group and the second subset of antennas associated with the second SRS port-group. The method may comprise sending a first power headroom report (PHR) for the first SRS port-group, and sending a second PHR for the second SRS port-group.

At least one example non-transitory computer-readable storage medium may comprise executable instructions for configuring at least one processor to facilitate SRS port-groups. The executable instructions may configure at least one processor to send capability information indicating a capability of the WTRU to support sounding reference signal (SRS) port-grouping, wherein a first SRS port-group comprises a first number of SRS ports and a second SRS port-group comprises a second number of SRS ports. The executable instructions may configure at least one processor to receive configuration information, wherein the configuration information may comprise an indication for the WTRU to support uplink (UL) transmission via the first SRS port-group in accordance with the first number of SRS ports and a second SRS port-group in accordance with the second number of SRS ports, wherein the first SRS port-group may comprise an association of a first subset of antennas for transmission of the first set of SRS ports and the second SRS port-group may comprise an association of a second subset of antennas for transmission of the second set of SRS ports. The executable instructions may configure at least one processor to transmit the first set of SRS ports via the first SRS port-group. The executable instructions may configure at least one processor to transmit the second set of SRS ports via the second SRS port-group. The capability information may comprise an indication that the WTRU is capable of jointly processing a received signal via all antennas associated with the first SRS port-group and the second SRS port-group. The capability information may comprise an indication that the WTRU is capable of independently processing the received signal via the first subset of antennas associated with the first SRS port-group and independently processing the received signal via the second subset of antennas associated with the second SRS port-group. The capability information may comprise an indication that the WTRU is capable of jointly processing a received signal via all antennas associated with the first SRS port-group and the second SRS port-group, and that the WTRU is capable of independently processing the received signal via the first subset of antennas associated with the first SRS port-group and independently processing the received signal via the second subset of antennas associated with the second SRS port-group. The capability information may comprise an indication of a maximum number of SRS port-group supportable by the WTRU. First DL CSI may be associated with the first SRS port-group. Second DL CSI may be associated with the second SRS port-group. The executable instructions may configure at least one processor to receive a downlink (DL) scheduling grant, wherein the DL scheduling grant may comprise an indication for the WTRU to support a DL reception via the first subset of antennas associated with the first SRS port-group or support DL reception via the second subset of antennas associated with the second SRS port-group. The configuration information may comprise a first transmission configuration indicator (TCI) indicative of processing a first codeword via the first subset of antennas associated with the first SRS port-group and a second TCI indicative of processing a second codeword via the second subset of antennas associated with the second SRS port-group. The executable instructions may configure at least one processor to process a first codeword via the first subset of antennas associated with the first SRS port-group, and process a second codeword via the second subset of antennas associated the second SRS port-group. SRS port grouping may be capable of being dynamically activated or deactivated via the DL scheduling grant. The executable instructions may configure at least one processor to receive a DL reference signal for pathloss estimation, and determine a pathloss associated with the first subset of antennas associated with the first SRS port-group and the second subset of antennas associated with the second SRS port-group. The executable instructions may configure at least one processor to send a first power headroom report (PHR) for the first SRS port-group, and sending a second PHR for the second SRS port-group.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a depiction of an example receiver illustrating single eight-port multiple input multiple output (MIMO) detection and demodulation.

FIG. 3 is a depiction of an example receiver illustrating dual four-port MIMO detection and demodulation.

### DETAILED DESCRIPTION

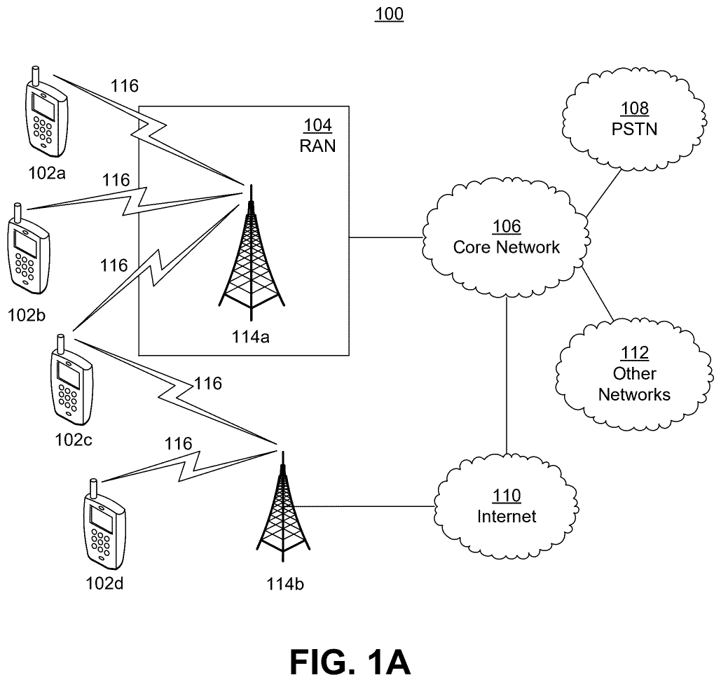

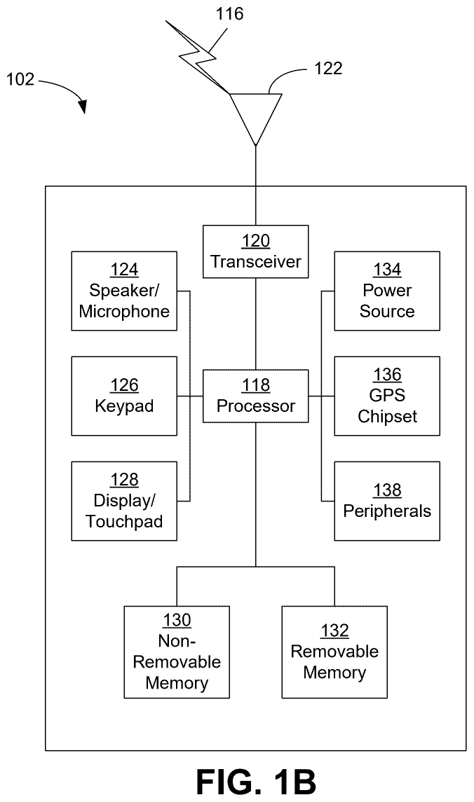

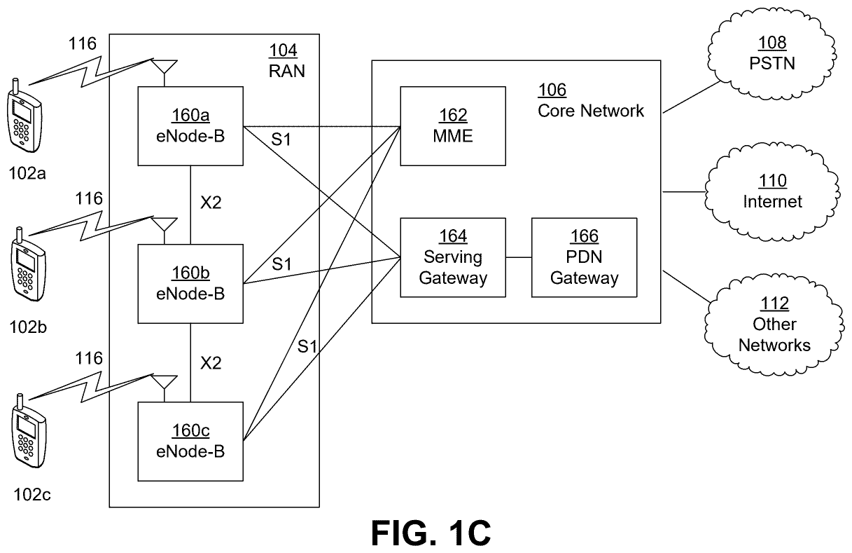

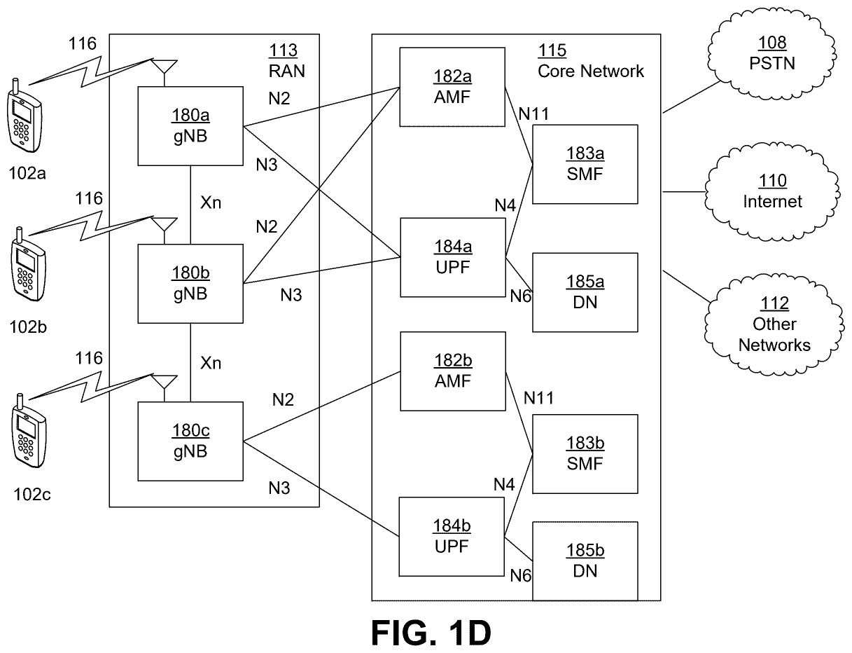

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL (uplink) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a cNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c.

Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as cNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, cNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Various methods, procedures, apparatuses, and mechanisms for sounding reference signal (SRS) port grouping are described herein. Low complexity receivers are used extensively in the use and application of cellular systems. In new radio (NR), transmission of two (2) codewords for downlink traffic may be realized for wireless channels that exhibit a higher rank indicator (RI) than four (4). Reception, detection, demodulation and decoding of 2 downlink codewords is a relatively complex and power-hungry process.

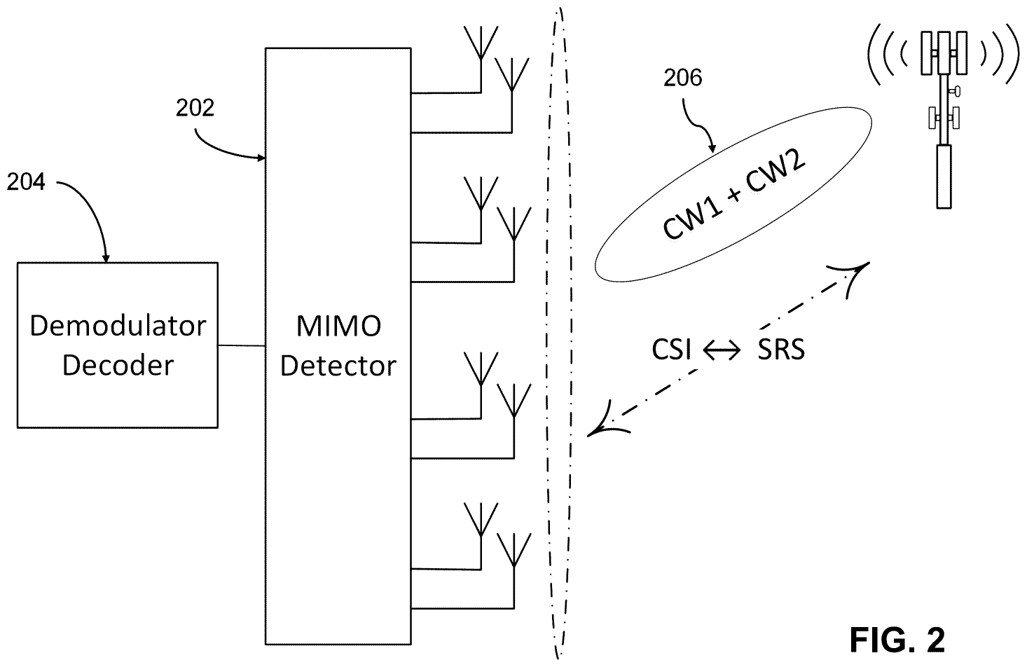

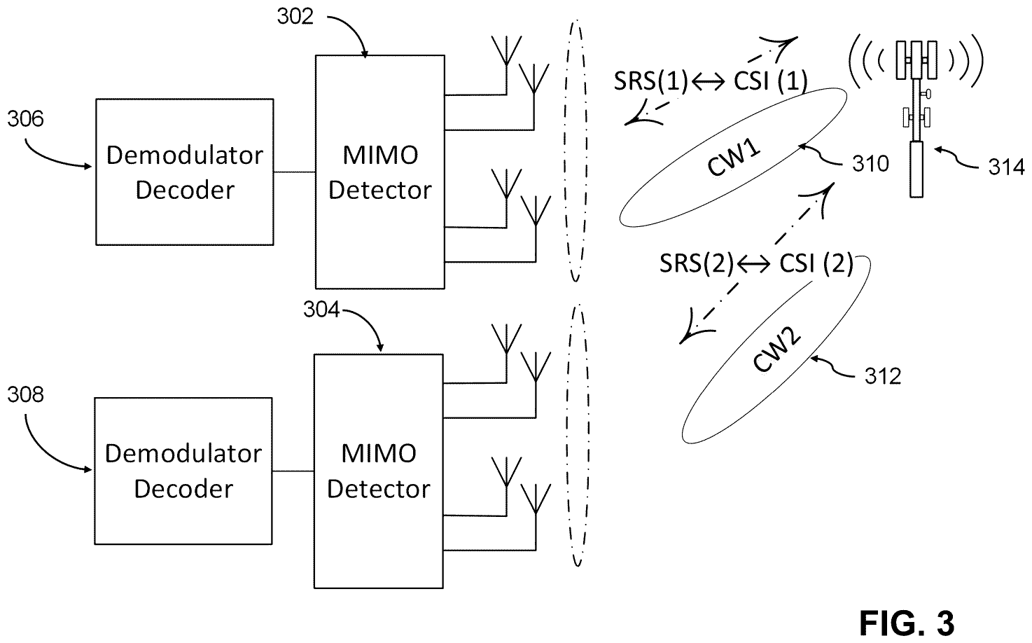

FIG. 2 is a depiction of an example receiver illustrating single eight-port multiple input multiple output (MIMO) detection (202) and demodulation (204). FIG. 2 illustrates an eight receiver (8Rx) architecture where the scheduled 2 codewords (206) are jointly received and processed at the receiver. In such receivers, the MIMO detector simultaneously processes eight (8) layers. FIG. 3 is a depiction of an example receiver illustrating dual four-port MIMO detection (302, 304) and demodulation (306, 308). In the receiver architecture depicted in FIG. 3, e.g., a low cost 8Rx, to reduce implementation complexity, instead of using a highly complex MIMO detector capable of processing 8 layers, two less complex 4-layer MIMO detectors are used. For example, when receiving a 2 codeword (310, 312) downlink transmission, each of the 4-layer MIMO detectors (302, 304) may be used for detection of one of the transmitted codewords (310, 312). To improve transmission quality of each codeword, each codeword may be precoded according to the channel observed between each of 4-layer MIMO detectors and network node (314), such as a Next Generation Node B (gNB).

Assuming reciprocity (in a time division duplex (TDD)-based system, for example), downlink precoding may be determined based on uplink measurements on a transmitted SRS. In a low-cost 8Rx receiver with independent 4-layer MIMO detectors, there may be independent SRS transmissions from each set of 4 antenna ports so that independent downlink channel state information (CSI), e.g., rank indicator (RI), channel quality indicator (CQI), etc., may be determined for reception by each of 4-layer MIMO detectors. As a result, SRS ports may be grouped and mapped to each antenna port-group to reduce inter-codeword interference and inaccurate CSI estimation.

Mechanisms to enable low-cost 6/8 Rx receivers to handle reciprocity-based transmissions (aka non-codebook-based transmissions) are described herein. However, the herein described mechanisms are not limited thereto. The herein described mechanisms also may be applicable to other types of transmissions, such as, for example, codebook-based downlink transmissions.

To enable efficient operation of the herein described low-cost receivers, the following mechanisms are addressed: defining and managing SRS port-groups, associating SRS port-groups and downlink CSI, determining Rx port-group for reception of a codeword in a single codeword transmission, determining RX port-groups for reception of each codeword in a 2 codeword transmission, and determining power for SRS transmission from each SRS port-group.

Regarding SRS port grouping, a WTRU may be configured/indicated with more than one SRS port-group, where for the grouping, one or more of the following may be applicable. Each SRS port-group may be a subset of SRS ports of the same configured SRS resource. Each SRS port-group may be the SRS ports associated with different SRS resources. Each SRS port-group may be the SRS ports associated with different SRS resource sets. Each SRS port-group may be the SRS port associated with a power rating that is different than the one of the other port-groups.

A WTRU may receive a dynamic indication for determining SRS antenna grouping, e.g., by a medium access control (MAC) control element (CE) or downlink control information (DCI). For example, a WTRU may be configured with N single port SRS resources, then it may receive two sounding reference signal indicators (SRIs), where a first SRI indicates the ports associated with a first SRS port-group, and a second SRI indicates the ports associated with a second SRS port-group. A downlink CSI may be associated with each SRS port-group.

A WTRU may indicate its receiver processing capability, for example, by sending capability information. For example, a WTRU may indicate whether it can jointly process the received signal on the entire set of antennas associated to more than one SRS port-groups (e.g., receiver combining), or each port-group can be processed independently.

When the WTRU receives a downlink scheduling grant, e.g., by a DCI, it may receive an indication for the associated port-groups for downlink (DL) reception, based on one of the following modes (e.g., Mode 1, Mode 2).

Mode 1 may indicate a direct group indication. If a WTRU is scheduled with more than one codeword, the received indication may determine port-groups for reception of each codeword (CW). For example, a single bit may be used to flag whether the first CW is to be processed by the first port-group. If a WTRU is scheduled with a single CW and has not indicated its capability for joint processing of received ports, the WTRU also may receive a single bit flag as an indication of the expected port-group for reception. (add motivation: power saving, add current assumption-only have and use one antenna group).

Mode 2 may indicate a transmission configuration indicator (TCI)-based indication. If a WTRU is scheduled with more than one codeword, e.g., two CWs, the WTRU may receive two-TCI information to indicate association of each CW to an SRS port-group. For example, a WTRU may receive two TCI fields where each TCI field may be associated with a different SRS port-group. In another example, a single TCI field may be received, where each TCI codepoint may correspond to a different pair of TCI values.

A WTRU may receive one or more DL antenna port indications, where each indicated DL antenna port represent the DL ports used for transmission of each CW. If only one antenna port is indicated, or both indicated antenna ports are the same, the WTRU may process each CW with the receive ports associated with any of the SRS port-groups. If two different sets of DL antenna ports are indicated, the WTRU may associate each CW with a different SRS port-group.

As described herein, an x-port SRS resource refers to an SRS resource that supports SRS transmission from x ports, regardless of its configuration. For example, an x-port SRS resource may be realized by configuring an x-port SRS resource. An x-port SRS resource may be realized by configuring (x+m)-port SRS resources, and blanking/muting/disabling m of its (x+m) ports.

A WTRU may be configured with N_{SRS} ports. The configured N_{SRS} ports may be supported within one or more SRS resource sets. If all N_{SRS} SRS ports are configured within a same SRS resource set, the configured N_{SRS} ports may be realized by one or more SRS resources. For example, a WTRU may receive a configuration for an SRS resource set with 2 SRS resources, where each SRS resource supports N_{SRS}/2 ports. In another example, a WTRU may be configured with N_{SRS} single port SRS resources.

N_{SRS} SRS ports may be supported by aggregation of more than one SRS resource set where each SRS resource set may comprise one or more SRS resources. For example, a WTRU may receive a configuration for 2 SRS resource sets where each of the configured sets may support N_{SRS}/2 ports. For mapping of ports to SRS resources, the WTRU may use one or more of the above-described mechanisms.

A WTRU may be configured and or indicated with more than one SRS port-groups, where for the grouping, one or more of the following may be applicable. When all N_{SRS} SRS ports are configured within a same SRS resource set, and the WTRU is configured with a single SRS resource per set, each SRS port-group may be a subset of SRS ports of the same configured SRS resource. For example, if a WTRU is configured with an SRS resource set containing a single N_{SRS}-port SRS resource, based on a criterion, a first and a second subset of ports may be considered.

When all N_{SRS} SRS ports are configured within a same SRS resource set, and the WTRU is configured with more than one SRS resource per set, each SRS port-group may be defined based on SRS ports supported by each configured SRS resource. For example, if a WTRU is configured with an SRS resource set containing 2 of N_{SRS}/2-port SRS resources, a first SRS port-group may be based on the SRS ports provided by the first SRS resource, and the second SRS port-group based on the ones provided by the second SRS resource.

When the N_{SRS} SRS ports are created by aggregation of more than one SRS resource set and each SRS resource set comprises at least one SRS resource, each SRS port-group may be defined based on ports of the indicated SRS resource per SRS resource set. For example, if a WTRU is configured with two SRS resource sets, the first port-group may be defined based on the ports supported by an SRS resource from the first SRS resource set, and the second port-group may be defined based on an SRS resource from the second SRS resource set.

In dividing N_{SRS} ports for multiple SRS port-groups, across ports within a same SRS resource, across multiple SRS resources or SRS resource sets, one or more of followings may be applicable. SRS ports may be distinguished based on their associated index. For example, with an 8-port SRS resource, the first and the second port-groups may be based on SRS ports {0, 1, 2, 3}, and {4, 5, 6, 7}. In another example, when 2 of 4-port SRS resources are configured, the ports associated with the first resource may be considered as the first port-group, and the ones of the second SRS resource may be considered as the second port-group. In another example, when 2 SRS resource sets are configured, the first port-group may be the ports associated with the first SRS resource set, and the second port-group may be associated with the second SRS resource set.

SRS ports may be distinguished based on the polarization of the antenna port. For example, with an 8-port SRS resource, the first and the second port-group may be based on the association with a first and a second polarization, e.g., the first and the second SRS port-groups may be mapped to the antenna subset associated with horizontal and vertical polarizations {h0, h1, h2, h3}, and {v0, v1, v2, v3}, respectively.

SRS ports may be distinguished based on the power rating associated to each antenna port. For example, with an 8-port SRS resource, the first and the second port-groups may be based on a first and a second power rating associated with the corresponding antenna ports, e.g., the first and the second SRS port-groups may be mapped to the antenna subset associated with {P1, P1, P1, P1}, and {P2, P2, P2, P2} power rating, respectively.

A WTRU may assume a fixed definition of SRS port-grouping or receive a semi-static or dynamic indication, e.g., by a MAC CE or a DCI, for the definition of SRS port-grouping. A WTRU may receive a configuration for support of a total of N_{SRS} ports. A WTRU may receive more than one SRS configuration, where one configuration is based on a conventional SRS configuration (e.g., no port-grouping), and one may be based on the new SRS port-grouping.

A WTRU may receive a DCI, to determine the assignment of an antenna port to a port-group. For example, a WTRU may receive one or more SRS port indications (SPIs), where an SPI indicates association of a subset of ports to a port-group. In an example, assuming two SRS port-groups, a WTRU may receive 2 SPIs, where the first SPI determines the ports associated with the first port-group, and the second SPI determines the ports associated with the second port-group.

Table 1 is a depiction of an example table illustrating a sounding reference signal indictor (SRI) indication for non-codebook based physical uplink shared channel (PUSCH) transmissions, wherein the maximum number of synchronization signal blocks (Lₘₐₓ) is 2. A WTRU may interpret a received SRI, as used for SRS resource indication for non-codebook-based PUSCH transmission. For example, assuming N_{SRS}=4 with 2 port-groups, a WTRU may interpret a received SRI as an SPI by reuse of the table depicted in Table 1 for determination of assignments of ports to each port-group. In the example Table 1, the codepoint shown by 4 in the original table represents assignment of ports 0 and 1 to a port-group. In an example with only 2 port-groups, where the total number of ports per group equals N_{SRS}, a WTRU may receive a single SPI indication.

TABLE 1

| | | | | | |
|---|---|---|---|---|---|
| Bit field | | Bit field | | Bit field | |
| Mapped | SRI(s), | Mapped | SRI(s), | Mapped | SRI(s), |
| to index | N_{SRS} = 2 | to index | N_{SRS} = 3 | to index | N_{SRS} = 4 |

| | |
|---|---|
| 4 | 0, 1 |
| 5 | 0, 2 |
| 6 | 0, 3 |
| 7 | 1, 2 |
| 8 | 1, 3 |
| 9 | 2, 3 |
| | reserved |

A WTRU may receive an indication to act upon a disable/enable (activate/deactivate) command in one or more of following cases. A WTRU may use the indication to enable/disable an SRS port-grouping and fall back on a default SRS configuration without any port-grouping. Once SRS port-grouping is enabled, the WTRU may assume the default SRS configuration is no longer valid. Once a WTRU is in a default SRS configuration, e.g., supporting 8 ports with no port-grouping, a received indication may signal one or more of the following. The WTRU may activate port-grouping, e.g., 2 port-group of 4 ports. The WTRU may activate one of the port-group.

A WTRU may use the indication as a command to turn off some part of the receiver function, e.g., RF frontend, demodulator, MIMO detector, decoder, etc. A WTRU may disable one of the port-group, if it is configured with a specific transmission parameter, e.g., max number of transmission layer, max number of codewords, etc. For example, if an 8Rx WTRU with SRS-port-grouping capability is configured to maximum 4 transmission layers, it may disable one of the port-groups, e.g., the second port-group. A WTRU may disable one of the port-group, if it is configured with a specific mode of operation. For example, a WTRU may disable one of the port-group when it enters to a power saving mode.

SRS port-groups may be associated with DL CSI. A WTRU may transmit (e.g., report, to a base station (BS), to a gNB, to a transmission and reception point (TRP)) information on its capability for the maximum number (G_max) of configurable SRS port-groups, where G_max may be 1 for the WTRU not supporting the SRS port-grouping feature, or an integer number larger than one, for the WTRU supporting the SRS port-grouping feature. For example, reporting G_max=1 may imply (e.g., represent) that the WTRU can jointly process the received signal on the entire set of antennas associated to more than one SRS port-groups (e.g., receiver combining). In an example, reporting G_max=2 may imply (e.g., represent) that for the WTRU each SRS port-group may be processed independently.

Hereafter, for the brevity of discussion, the reported capability value of G_max=2 may be considered to represent a WTRU supporting two SRS port-groups, however the proposed mechanisms, apparatuses, methods, and processes may equally (or equivalently or extendedly, etc.) be employed for cases with other cases of G_max=3 or larger number.

The WTRU may receive an indication or configuration confirming the reported value of G_max or receiving an updated parameter value that is smaller than the reported G_max. In an example, based on the WTRU receiving a confirmed value of G_max=2, the WTRU may receive an explicit or implicit SRS port-group identifier (e.g., SPG-ID, to be either 1 or 2) associated with an SRS resource, an SRS resource set, and/or an SRS-config parameter. The WTRU may receive an explicit or implicit SRS port-group identifier (e.g., SPG-ID, to be either 1 or 2) associated with a download-reference signal (DL-RS) (e.g., SSB, CSI-RS) resource, a DL-RS (e.g., synchronization signal block (SSB), CSI-RS) resource set, and/or a measurement reference signal (RS) configuration (e.g., being associated with a CSI or beam reporting).

In an example, the WTRU may receive configuration on a first SRS resource set being associated (e.g., configured) with SPG-ID #1, and a second SRS resource set being associated (e.g., configured) with SPG-ID #2.

Based on the configuration on the first SRS resource set, the WTRU may transmit a first SRS associated with an SRS resource of the first SRS resource set, and on condition that (later) the WTRU receives a control command (e.g., DL grant, DL monitoring, DL measurement trigger) to receive (or measure) a DL signal or channel, that is/are associated with SPG-ID #1, the WTRU may receive (or measure) the DL signal or channel based on SPG-ID #1, e.g., based on using (only) a first antenna port-group that had been used for transmitting the first SRS. The DL signal or channel may be at least one of a physical downlink shared channel (PDSCH), a physical downlink control channel (PDCCH) (e.g., DCI via a control resource set (CORESET)), a CSI-RS, an SSB, a demodulation-reference signal (DM-RS), a tracking reference signal (TRS), and/or a phase tracking-reference signal (PT-RS).

Based on the configuration on the second SRS resource set, the WTRU may transmit a second SRS associated with an SRS resource of the second SRS resource set, and on condition that (later) the WTRU receives a control command (e.g., DL grant, DL monitoring, DL measurement trigger) to receive (or measure) a DL signal or channel, that is/are associated with SPG-ID #2, the WTRU may receive (or measure) the DL signal or channel based on SPG-ID #2, e.g., based on using (only) a second antenna port-group that had been used for transmitting the second SRS. The DL signal or channel may be at least one of a PDSCH, a PDCCH (e.g., DCI via a CORESET), a CSI-RS, an SSB, a DM-RS, a TRS, and/or a PT-RS.

A direct antenna port-group may be indicated. When the WTRU receives a downlink scheduling grant, e.g., by a DCI, it may receive an explicit (or implicit) indication for the associated port-group(s) for DL reception. The WTRU may receive a direct group indication. If the WTRU is scheduled with more than one codeword (e.g., which may be indicated by an existing DCI field, e.g., DM-RS field, or a separated field), the WTRU may determine, based on the received indication, port-groups for reception of each CW. For example, (e.g., for the explicit indication), a single bit may be used to flag whether the first CW is to be processed by the first port-group (e.g., based on the first SRS resource set, associated with SPG-ID #1) and/or whether the second CW is to be processed by the second port-group (e.g., based on the second SRS resource set, associated with SPG-ID #2), e.g., or vice versa.

If the WTRU is scheduled with a single CW and has not indicated its capability for joint processing of received ports (e.g., when the WTRU reports its capability as G_max being larger than 1), the WTRU may (also) receive a single bit flag as an indication of the expected port-group for reception, e.g., either with SPG-ID #1 or SPG-ID #2 (selectively). In an example, even though the WTRU reported its capability as G_max>1, the WTRU may receive information for enabling (e.g., turning-on) at least one of the antenna port-groups, e.g., via a DCI indicating the single bit flag for selecting at least one antenna port-group dynamically, or via a higher-layer signaling (e.g., MAC-CE and/or radio resource control (RRC)) to semi-statically activate (e.g., turn-on) at least one antenna port-group(s) for subsequent DL and/or UL communications. This may provide benefits in terms of power saving on the WTRU's operation where the WTRU may turn off (e.g., deactivate) at least one of the antenna port-groups and be able to use only a part of the whole antenna (e.g., antenna ports) for DL and/or UL communications.

The explicit (or implicit) indication may comprise a TCI-based indication. If the WTRU is scheduled with more than one codeword (e.g., which may be indicated by an existing DCI field, e.g., DM-RS field, or a separated field), e.g., two CWs, the WTRU may receive two sets of TCI-related information to indicate association of each CW to an SRS port-group. In an example, the WTRU may receive two TCI fields where each TCI field may be associated with a different SRS port-group (e.g., SPG-ID #1 or #2). In another example, a single TCI field may be received, where each TCI codepoint may correspond to a different pair of TCI values, e.g., each being associated with either of SPG-ID #1 or SPG-ID #2.

In an example, the WTRU may receive (or determine) a first indicated TCI-state and a second indicated TCI-state to be used for a DL reception and/or a UL transmission, where the WTRU may receive (or determine) that the first indicated TCI-state is associated with either SPG-ID #1 or SPG-ID #2, and/or that the second indicated TCI-state is associated with either SPG-ID #1 or SPG-ID #2. The WTRU may separately receive information (e.g., via a MAC-CE and/or RRC) on the association between an indicated TCI-state and an antenna port-group or groups (e.g., SPG-ID #1 or #2), e.g., separately from the scheduling DCI, which may imply that the WTRU may already know the association and when the WTRU receives a scheduling grant, the WTRU may determine the mapping between a scheduled CW and at least one of antenna port-group(s) that is/are subject to be used for a reception or transmission according to the scheduling grant. This may provide robustness in that the scheduling grant transmitted by the BS can be based on measuring the transmitted SRS from the WTRU based on the indicated SPG-ID tag information (e.g., SPG-ID #1 or #2) such that the BS can ensure the intended WTRU behavior for the reception or transmission by using selected antenna port-group(s) that is/are synchronized between the WTRU and the BS.

Antenna port-groups for reception may be determined. Antenna port-grouping may be determined for transmission and/or reception. The antenna ports on an antenna panel at a transmitter (Tx) or a transmitting side (or alternatively, at a receiver (Rx) or a receiving side) may be portioned or divided into one or more groups of antenna ports. Each antenna group may be associated with a specific port-group of a reference signal, e.g., SRS, CSI-RS, DM-RS, etc.

Hereafter, for brevity and broadness of discussion, a reference signal associated port-group (e.g., SRS port group) and antenna port-group is used interchangeably. For example, a transmitter may have Nₜ antenna ports divided into four antenna groups (e.g., Tx groups). A receiver may have Nᵣ antenna ports divided into four antenna groups (e.g., Rx groups). Each transmit antenna port-group may contain one or more antenna ports. For example, a first group of antenna ports may include antenna ports with indices,

$${P}_{1} = 1 , ⋯ , \frac{{N}_{t}}{2} .$$

A second group of antenna ports may include antenna ports with indices,

$${P}_{2} = \frac{{N}_{t}}{2} + 1 , ⋯ , {N}_{t} .$$

A third group of antenna ports may include antenna ports with indices, P₃=1, 3, 5, . . . , Nₜ−1. A fourth group of antenna ports may include antenna ports with indices, P₄=2, 4, 6, . . . , Nₜ.

Each receive antenna port-group may contain one or more antenna ports. For example, a first group of antenna ports includes antenna ports with indices,

$${S}_{1} = 1 , ⋯ , \frac{{N}_{r}}{2} .$$

A second group of antenna ports may include antenna ports with indices,

$${S}_{2} = \frac{{N}_{r}}{2} + 1 , ⋯ , {N}_{r} .$$

A third group of antenna ports may include antenna ports with indices, S₃=1, 3, 5, . . . , Nₜ−1. A fourth group of antenna ports may include antenna ports with indices, S₄=2, 4, 6, . . . , Nᵣ.

A WTRU may be configured for one or more rules or associations between Tx and Rx antenna port-groups. The rules or associations may be configured semi-statically or dynamically. For example, through RRC, the WTRU may be configured for a first, second or a first and a second association. Through MAC-CE, the WTRU may be configured for a second or a third association or a second and a third association. Using DCI, the WTRU may be configured for a first or a third rule or a first and a third association.

Each of the configured associations may define, explain, depict, illustrate or draw an association, mapping, or relation between one or more of the following: Tx port-groups used at the transmitter for transmission of the downlink transmissions; Rx port-groups) used at the receiver for reception of the downlink transmissions' Indices of Tx port-group used at the transmitter for transmission of the downlink transmissions; Indices of Rx port-group used at the receiver for reception of the downlink transmissions; Number of codewords or number of transport blocks; Association of a codeword with Tx port-groups at transmitter and Rx antenna port-group(s) at the receiver; and/or TRP indices.

Table 2 is a table illustrating example antenna port-groups, antenna port indices in antenna port-groups, number of codewords, and codeword indices association with 16 association states. Table 2 depicts example associations of antenna port groups. The term, “association state” may be interpreted, treated or explained throughput this disclosure as a mapping or relation between one or more of the antenna port-groups, codewords, and/or TRPs, etc. For example, a single row of Table 2 (e.g., row 1 identified by bits “0000”) is an example of an association state. Each of the association states presented in Table 2 based on Tx port-groups (e.g., Group index(es) and Port index(es)) and Rx port-groups (e.g., Group index(es) and Port index(es)) may be used by a receiver, a transmitter, or a reflector (e.g., a gNB, an eNodeB, a base-station, a WTRU, a TRP, a reconfigurable intelligent surfaces (RIS)) as explained in the following examples.

TABLE 2

| | | | Tx port-group(s) | | Rx port-group(s) | | |
|---|---|---|---|---|---|---|---|
| | | | Group | Post-group | Group | Post-group | Number of |
| | No. | Bits | index(es) | index(es) | index(es) | index(es) | Codewords |
| Association State 1→ | 1 | 0000 | 1 | P₁ | 1 | S₁ | 1 |
| | 2 | 0001 | 2 | P₂ | 3 | S₃ | 1 |
| | 3 | 0010 | 3 | P₃ | 1 | S₁ | 1 |
| | 4 | 0011 | 4 | P₄ | 2 | S₂ | 1 |
| Association State 5→ | 5 | 0100 | 1, 2 | P₁, P₂ | 4 | S₄ | 1 |
| | 6 | 0101 | 3, 4 | P₃, P₄ | 4 | S₄ | 1 |
| | 7 | 0110 | 4 | P₄ | 1, 2 | S₁, S₂ | 1 |
| Association State 8→ | 8 | 0111 | 4 | P₄ | 3, 4 | S₃, S₄ | 1 |
| | 9 | 1000 | 1, 2 | P₁, P₂ | 1, 2 | S₁, S₂ | 1 |
| | 10 | 1001 | 1, 2 | P₁, P₂ | 3, 4 | S₃, S₄ | 1 |
| | 11 | 1010 | 1, 2 | P₁, P₂ | 1, 2 | S₁, S₂ | 2 |
| | 12 | 1011 | 1, 2 | P₁, P₂ | 3, 4 | S₃, S₄ | 2 |
| | 13 | 1100 | 3, 4 | P₃, P₄ | 1, 2 | S₁, S₂ | 2 |
| Association State 14→ | 14 | 1101 | 3, 4 | P₃, P₄ | 3, 4 | S₃, S₄ | 2 |

| | | | | |
|---|---|---|---|---|
| Association State 15→ | 15 | 1110 | Fallback | 1 |
| Association State 16→ | 16 | 1111 | Fallback | 2 |

Association State 1, depicted in Table 2, corresponds to row indexed 1 identified by bits, “0000”. The transmitter (e.g., network node, gNB) may use the first transmit antenna port-group that includes antenna port,

$${P}_{1} = 1 , ⋯ , \frac{{N}_{t}}{2}$$

for transmission of a one codeword or one transport block and the receiver (e.g., WTRU) may receive the transmitted codeword or the transmitted transport block using the first set of receive antenna group that includes receive antenna ports

$${S}_{1} = 1 , ⋯ , \frac{{N}_{r}}{2} .$$

Association State 5, depicted in Table 2, corresponds to row indexed 5 and identified by bits, “0100”. The transmitter (e.g., network node, gNB) may use the first transmit antenna port-group that includes antenna ports,

$${P}_{1} = 1 , ⋯ , \frac{{N}_{t}}{2}$$

and the second transmit antenna port-group that includes antenna ports,

$${P}_{2} = \frac{{N}_{t}}{2} + 1 , ⋯ , {N}_{t}$$

for transmission of a one codeword or one transport block and the receiver (e.g., WTRU) may receive the transmitted codeword or the transmitted transport block using the fourth receive antenna group that includes receive antenna ports S₄=2, 4, 6, . . . , Nᵣ.

Association State 8, depicted in Table 2, corresponds to row indexed 8 and identified by bits, “0111”. The transmitter (e.g., network node, gNB) may the fourth transmit antenna port-group that includes antenna ports, P₄=2, 4, 6, . . . , Nₜ for transmission of a one codeword or one transport block and the receiver (e.g., WTRU) may receive the transmitted codeword or the transmitted transport block using the third receive antenna port-group that includes antenna ports S₃=1, 3, 5, . . . , Nₜ−1 and the fourth antenna port-group that includes receive antenna ports S₄=2, 4, 6, . . . , Nᵣ.

Association State 14, depicted in Table 2, corresponds to row indexed 14 and identified by bits, “1101”. The transmitter (e.g., network node, gNB) may use the third transmit antenna port-group for transmission of the first codeword and the WTRU may use the third receive antenna port-group for reception of the first codeword. The transmitter (e.g., network node, gNB) may use the fourth transmit antenna port-group for transmission of the second codeword and the WTRU may use the fourth receive antenna port-group for reception of the first codeword.

Association State 15, depicted in Table 2, corresponds to row indexed 15 and identified by bits, “1110”. The transmitter and the receiver fallback, may go back or switch back to the legacy or default mode of operation where all the transmit antenna ports at the transmitter are used for transmission of a single codeword and all receiving antenna at the receiver are used for reception of the transmitted single codeword.

Association State 16, depicted in Table 2, corresponds to row indexed 16 and identified by bits, “1111”. The transmitter and the receiver fallback, may go back or switch back to the legacy or default mode of operation where all the transmit antenna ports at the transmitter are used for transmission of two codewords and all receiving antennas at the receiver are used for reception of the transmitted two codewords.

An association state may be explicitly indicated. A WTRU may be semi-statically or dynamically configured (e.g., by RRC, MAC-CE, and/or DCI) for an association rule (e.g., on a row of Table 2, e.g., row 1 identified by bits “0000” or row 2 identified by bits “0001” in Table 2). Based on the configuration or indication of the association rule (e.g., a row of the table depicted in Table 2), the WTRU may determine to transmit antenna indices used for transmission of a codeword by a TRP and receive antenna indices to be used for reception of a transmitted codeword by the TRP.

A WTRU may be semi-statically (e.g., by RRC) configured on one or more associations or rules, e.g., Association State 1 and Association State 2. For example, Table 2 is an example of Association State 1 and a variant (e.g., a different version) of Table 2 is an example of Association State 1. The WTRU may be dynamically (e.g., by DCI) configured on one of the semi-statically configured associations using an existing DCI field or a new DCI field. For example, through DCI, the WTRU may be configured on Association State 1 of Table 2. The DCI may also include another existing or a new filed to trigger, indicate, or configure one of the association state, e.g., one out of the 16 association states depicted in Table 2. For example, a first DCI field may indicate or configure an association rule, e.g., Association State 1 or Association State 2. A second DCI field may indicate or configure one state (e.g., a row index as identified by bits, “0000” to bits “1111” in Table 2) defined by the configured or indicated association by the first DCI field. A second DCI field may indicate or configure one state (e.g., a row index as identified by bits, “0000” to bits “1111” in Table 2) defined by the semi-statically (e.g., by RRC) configured association (e.g., Table 2), (e.g., Table 2 configured by RRC).

An association state may be implicitly indicated. A transmitter (e.g., gNB) may implicitly indicate an association state to the WTRU based on at least one of the following. For example, an association state may be implicitly indicated to the WTRU based on the mapping type used for DL transmissions (e.g., PDSCH mapping type-A and/or type-B). When the gNB uses a first mapping type of DL transmission (e.g., PDSCH mapping type-A), the WTRU may use a first association state for reception of DL transmission. When the gNB uses a second mapping type (e.g., PDSCH mapping type-B), the WTRU may use a second association state for reception of the DL transmissions.

An association state may be implicitly indicated to the WTRU based on the number of DL transmission repetitions. For example, when the DL transmission occurs only one time, a first association state may be used. When the DL transmission is repeated two times or occurs two times, a second association state may be used. When the DL transmission is repeated two times or occurs two times, a first association state may be used at a first DL transmission instance and a second association state may be used at the second DL transmission instance.

An association state may be implicitly indicated to the WTRU based on whether the transmission is an initial transmission or a retransmission. For example, for an initial transmission, a WTRU may use a first association, and for all follow up re-transmissions, it may use one another association. In another example, for an initial transmission, a WTRU may use a first association, and for every follow up re-transmissions, it may use a different association.

An association state may be implicitly indicated based on the subcarrier spacing used for DL transmission. For example, when a first subcarrier spacing is used for DL transmission, the WTRU may use a first association state for reception of the DL transmission. When a second subcarrier spacing is used for DL transmission, the WTRU may use a second association state for reception of the DL transmission.

An association state may be implicitly indicated based on start symbol of DL transmission. An association state may be implicitly indicated based on where the DL transmissions to the WTRU begins. For example, when DL transmission to the WTRU begins at the first symbol in a slot, the WTRU may use a first association state for reception of the DL transmission. When DL transmission to the WTRU begins at the second symbol in a slot, the WTRU may use a second association state for reception of the DL transmission.

An association state may be implicitly indicated to the WTRU based on the length of a DL transmission. An association state may be implicitly indicated to the WTRU based on the number of time-units (e.g., number of symbols, slots, frames, and/or sub-frame etc.) and/or based on the number of frequency-units (e.g., sub-carriers, RE, bands, sub-band, and/or bandwidth parts, etc.). For example, when DL transmissions are expected to last 3 symbols, the WTRU may use a first association state for the duration of 3 symbols to receive the DL transmission. When DL transmissions are expected to last 5 symbols, the WTRU may use a second association state for the duration of 3 symbols to receive the DL transmission.

An association state may be implicitly indicated to the WTRU based on a slot offset between DCI and its scheduled DL transmission. An association state may be implicitly indicated based on the time-unit(s) (e.g., slots) offset between the DCI and its scheduled DL transmission or based on the number of time-unit(s) (e.g., number of slots, symbols, and/or frames) between the DCI and its scheduled DL transmission. For example, when the slot offset between the DCI and PDSCH equal 2 slots, the WTRU may use a first association state for reception of the PDSCH. When the slot offset between the DCI and PDSCH equal 5 slots, the WTRU may use a second association state for reception of the PDSCH.

An association state may be implicitly indicated to the WTRU based on a number of PDSCHs configured per PDCCH. For example, when the number of configured PDSCHs per PDCCH is one, the WTRU may use a first association state for reception of the PDSCH. When the number of configured PDSCHs per PDCCH is two, the WTRU may use a second association state for reception of the two PDSCHs, or the WTRU may use a first association state for reception of the first PDSCH and a second association state for reception of the second PDSCH.

A WTRU may do one or more of the following to manage power (e.g., manage power saving requirements). A WTRU may request or indicate power saving mode or energy saving mode for one or more antenna port-groups at the receiver. For example, the WTRU may indicate that it needs to switch off or turn off one or more antenna port-groups for energy savings. The WTRU may indicated that it needs to switch off two antenna port-groups for reception of DL transmission.

The WTRU may not explicitly or implicitly indicate the index(es) of one or more antenna port-group(s) to the gNB but may declare or indicate that it needs to go to a power saving mode for one or more antenna port-groups. For example, the WTRU may not declare or indicate that it needs or wishes to turn off or switch off the first and/or second antenna port-group.

The WTRU may not expect to be configured or indicated for one or more association states that requires a number of antenna ports or antenna port-groups greater than the WTRU requested for reception of the DL transmissions. For example, when the WTRU declares that it wishes to switch off or turn off all antenna port-groups except one antenna port-group for reception of the DL transmission, the WTRU may not expect to be configured on row indexes 7-14 of Table 2, that requires two antenna port-groups for reception of the DL transmission.

The WTRU may explicitly or implicitly indicate one or more specific antenna port-groups that it wishes for reception of the DL transmissions. For example, the WTRU may indicate that it wishes or needs to turn off or switch off all antenna port-groups for DL receptions except the first (e.g., S₁) antenna port-group. The WTRU may expect that it will only be configured on row indexes 1 (identified by “0000”) and 3 (identified by 0010) of Table 2.

The WTRU may interpret bits of the DCI field indicating the association state as follows. The WTRU may consider the first X, last X, middle X number of bits to retrieve the association state that the gNB is indicating through the DCI field, where the number of bits X may depend on the number of valid association states, where an association state assumed, considered, or treated as valid if the WTRU expects to be configured on that association state and is assumed invalid if the WTRU does not expects to be configured on that association state. For example, when the WTRU indicates that it wishes or needs to turn off or switch off all antenna port-groups for DL receptions except the first (e.g., S₁) antenna port-group, the first association state and the third association state is valid, and the remaining association states are invalid. The WTRU may determine X as X=log₂(number of valid association states). The WTRU may consider the first bit, e.g., the most significant bit or alternatively the least significant bit to determine which association state to use for reception of the DL transmissions.

According to a power control procedure for each SRS port-group, such as a power control for SRS transmission by each SRS port-group, for example, a WTRU may be configured with at least one DL reference signal for pathloss estimation. The WTRU may determine one pathloss per received antenna ports associated with each SRS port-group. The WTRU may determine power for SRS transmission by each SRS group by applying a different pathloss. The WTRU may consider one SRS port-group as a reference, e.g., the group with the lowest index. The WTRU may determine the SRS power for the reference group, and then apply an offset for the power associated to the other SRS port-groups. The WTRU may receive a separate transmission power control (TPC) command for each SRS port-group. The WTRU may compute and report different power headroom report (PHR) per SRS port-group.

A WTRU may be configured with one or more DL reference signal(s) to estimate the path loss (PLs) for each SRS port-group. The estimated PLs may play a role in SRS power control for each group since it helps the WTRU determine how much additional power is needed to compensate for signal degradation over the wireless channel for each group. The relation between path loss and SRS power allocation may be tied to the concept of fractional power control, where the WTRU may adjust its transmit power based on the PL but might not fully compensate for it, depending on network configuration.

The WTRU may estimate the PL for Group 1 (g1) as:

$${PL}^{g 1} = {P}_{DL}^{g 1} - {P}_{RSRP}^{g 1} , where {P}_{DL}^{g 1}$$

is the power of DL reference signal transmitted by gNB and

$${P}_{RSRP}^{g 1}$$

is the power of the reference signal received by the WTRU for Group 1.

The WTRU may estimate the PL for Group 2 (g2) as:

$${PL}^{g 2} = {P}_{DL}^{g 2} - {P}_{RSRP}^{g 2} , where {P}_{DL}^{g 2}$$

is the power of DL reference signal transmitted by gNB and

$${P}_{RSRP}^{g 2}$$

is the power or the reference signal received by the WTRU for Group 2.

$${P}_{RSRP}^{g 1} and {P}_{RSRP}^{g 2}$$

may be estimated based on different configured DL reference signals and/or port-groups at gNB, e.g., CSI-RS1 and CSI-RS2.

To control the SRS power for each port-group, PL^{g1} and PL^{g2} may be included in the power allocation formula through a parameter a known as the fractional path loss compensation factor (FPLCF) for each group. The relation is as follows.

For port-group 1:

$${P}_{SRS}^{g 1} = min ( {P}_{{C}_{max}}^{g 1} , {P}_{0}^{SRS , g 1} + {α}^{g 1} \cdot {PL}^{g 1} + {δ}_{TF}^{g 1} )$$

For port-group 2:

$${P}_{SRS}^{g 2} = min ( {P}_{{C}_{max}}^{g 1} , {P}_{0}^{SRS , g 2} + {α}^{g 2} \cdot {PL}^{g 2} + {δ}_{TF}^{g 2} ) , where {P}_{SRS}^{g 1} and {P}_{SRS}^{g 2}$$

are transmitted power for SRS in Group 1 and Group 2,

$${P}_{0}^{SRS , g 1} and {P}_{0}^{SRS , g 2}$$

are the base power level for SRS transmission for in Group 1 and Group 2, respectively. α^{g1} and α^{g2} are the FPLCFs for Group 1 and Group 2, respectively. The values are between 0 and 1. PL^{g1} and PL^{g2} are the estimated path loss for Group 1 and Group 2, respectively.

$${δ}_{TF}^{g 1} and {δ}_{TF}^{g 2}$$

are the transmitted power offset for Group 1 and Group 2, respectively.

If α=1 for any group, the SRS power control fully compensates for the path loss in that group. This means that for every dB increase in path loss, the WTRU may increase the transmit power by 1 dB for each group that its fractional path loss compensation factor is equal to 1. If α=0 for any group, the WTRU may not compensate for path loss at all in that group, and its SRS transmit power will remain fixed for that group, regardless of path loss. If 0<<α<1 for any group, the WTRU is allowed for fractional compensation, where the WTRU may increase its power partially in response to increasing path loss. For example, if α=0.5 for any group, it means that for every 2 dB increase in path loss, the WTRU will increase its transmit power by 1 dB.

The WTRU may be configured with FPLCFs, e.g., α^{g1} and α^{g2}, to balance performance and interference for each group jointly or separately. For example, a higher α^{g1} (e.g., α^{g1}>α^{g2}) allows the WTRU to transmit more power for the Group 1 when the path loss is higher (e.g., PL^{g1}>PL^{g2}), improving link quality, but it also increases interference to Group 2. In another example, a lower α^{g1} (e.g., α^{g1}<α^{g2}) reduces the interference but can result in poorer link quality for UEs that are far from the gNB. In another example, the gNB may decide one group has a higher priority based on the pathloss and set α=0 for the other group with lower priority. This allows the WTRU to control SRS power consumption to serve the WTRUs with higher priority. In another example, the WTRU may measure the interference between the two groups in order for gNB to set α^{g1} and α^{g2}.

In addition to the interference between two groups, the network may consider the other parameters such as the interference between the WTRUs in the other cells, network conditions, the number of WTRUs, and the deployment scenario to configure FPLCFs. For example, in dense urban environments where many WTRUs are close to a gNB, the network might employ a lower α^{g1} and α^{g2} to reduce interference. In another example, in rural environments, where WTRUs are far apart, a higher α^{g1} and α^{g2} may be used to ensure good link quality for WTRUs located far from gNB.

The WTRU may consider one SRS port-group, e.g., Group 1 as a reference group and determine the SRS power, i.e.,

$${P}_{SRS}^{g 1} ,$$

for the reference group based on

$${δ}_{TF}^{g 1} .$$

Then, the WTRU may apply an offset to the other SRS port-groups, i.e.,

$${δ}_{TF}^{g 2}$$

to adjust the SRS power tor that group, i.e,

$${P}_{SRS}^{g 2} .$$

For example, the WTRU may be configured with α^{g1}, α^{g2},

$${δ}_{TF}^{g 1}$$

and a set of values for

$${δ}_{TF}^{g 2}$$

so that the WTRU may be able to pick up a value from the set and inform gNB. In another example, the WTRU may be configured with α^{g1}, α^{g2},

$${δ}_{TF}^{g 1}$$

and a set of values for

$${δ}_{TF}^{g 2} .$$

set for

$${δ}_{TF}^{g 2}$$

to reduce the interference. In another example, the WTRU may be configured with α^{g1}, α^{g2},

$${δ}_{TF}^{g 1}$$

and a set

$${δ}_{TF}^{g 2}$$

such that

$${P}_{0}^{SRS , g 2} + {α}^{g 2} \cdot {PL}^{g 2} + {δ}_{TF}^{g 2} < {P}_{{C}_{max}}^{g 2} .$$

This may set the reference group at a higher priority for power allocation. In another example, the WTRU may continuously receive feedback from gNB regarding SRS transmission power adjustments for Group 2 in a feedback loop. This feedback loop may be based on the reference signal received power (RSRP), the channel quality indicators (CQIs), the interference between the two SRS groups, or any appropriate combination thereof.

The WTRU may receive a separate transmission power control (TPC) command for each SRS port-group. The WTRU power may be controlled dynamically by a TPC command. The WTRU transmission power may be controlled by some feedback inputs from gNB. In this way, overall power control is processed from a closed loop.

A TPC for each group may be configured for the WTRU based on a target SNR/SNIR (signal to noise ratio/signal interference plus noise ratio), a measured SNR/SNIR, a power headroom report, or any appropriate combination thereof.

A WTRU may determine to report a power headroom report (PHR) with power headroom (PH) values for multiple SRS port-groups. A WTRU may determine PH for a TRP based on the difference between a calculated power (e.g., based on a DCI format or grant's resource allocation in RB) and a maximum power (e.g., the WTRU's maximum transmit power Pcmax). The calculated power is also a function of the pathloss measured on a reference signal (e.g., CSI-RS or SSB). The PH Report (PHR) can be for a PUSCH transmission (Type 1), for an SRS transmission (Type 3), or for simultaneous PUSCH and PUCCH transmission (Type 3). The WTRU may include multiple PH types in one PHR, and a power backoff (power management maximum power reduction (P-MPR)).

The PH value may be a real value based on an allocated grant from a PUSCH, or it may be a virtual value based on a reference grant (e.g., single RB allocation). The WTRU may transmits a PHR in an UL transmission (e.g., PUSCH) after the WTRU determines to trigger a PHR. A WTRU may trigger a PHR based on one or more conditions: expiry of a timer (e.g., phr-ProhibitTimer or phr-PeriodicTimer), change of a PL value greater than a threshold (phr-Tx-PowerFactorChange) since last PHR transmission, or change of power backoff (e.g., P-MPR) greater than a threshold since last PHR transmission. If the WTRU determines that one of these conditions is satisfied, the WTRU may trigger a PHR transmission in a MAC-CE which may be contained in a TB of a PUSCH transmission. The PH type and value that the WTRU includes in the PHR may depend on the triggered condition.

Separate triggering conditions may be configured per SRS port-group, and the WTRU may trigger the PHR separately per SRS port-group. The WTRU may receive a configuration where each SRS port-group may have its own pathloss thresholds and timer. The WTRU may independently trigger a PHR per SRS port-group based on the triggering conditions determined per SRS port-group. The same or different pathloss reference RS may be configured on the SRS port-groups. For example, the WTRU may determine that the reference RS on the first SRS port-group may fall below a threshold since the last PHR for the first SRS ports group. Then the WTRU is triggered for a PHR only associated to the first SRS port-group. If the second SRS ports group also triggers a PHR before the WTRU reports the first PHR for the first SRS port-group, then the WTRU may jointly report PH values for both SRS port-groups in a single PHR. Alternatively, the WTRU may transmit separate PHRs.

In existing NR systems, the PHR is determined for the different types assuming there are no port-groups configured. If SRS port-groups are defined, then the PHR value and types are not well defined.

In another example, the WTRU may report one PH value per SRS port-group in a joint PHR regardless of which SRS port-group's triggering condition is activated. The WTRU may determine whether the PH value is virtual or real as a function of which SRS group's triggering condition is activated. The WTRU may report a real PH value for the SRS group which triggered a PHR. For example, if only SRS port-group 1's condition is activated, the WTRU may report a real PH value associated to the first SRS port-group, and a virtual PH value associated to the second SRS port-group. The WTRU may include both values in a joint PHR MAC-CE that is transmitted on the next available PUSCH grant.

The WTRU may determine to report a real or virtual PH value as a function of the number of codewords or layers in the scheduling grant. Since each SRS port-group may be associated to one codeword, then the WTRU may report a real PH value for the SRS port-groups that are indicated in the scheduling grant. For example, the grant may indicate a 4-layer transmission that only uses SRS port-group 1. If the WTRU determined that both PHR are triggered, then the v may determine to report a real PH value for SRS port-group 1, and a virtual value for SRS port-group 2. If the grant indicates more than 4 layers (which uses SRS port-group 1 and 2) or if the number of SRS port-groups is explicitly indicated, then the WTRU may report a real PH value for each. Alternatively, the WTRU may report real values for both SRS port-group if only one of the SRS port-groups is indicated in the scheduling grant. The WTRU may assume to use the resource allocation from the grant for both SRS ports groups to determine a PHR for the inactive SRS port-group.

The SRS port-groups may be dynamically activated/deactivated through the grant, or the association of ports to port-groups may be reconfigured by the network (e.g., RRC). As a new triggering condition, the WTRU may be triggered to report a PHR whenever one of the SRS port-groups is activated or whenever the port-groups are reconfigured. A timer may be configured starting when the SRS port-group is activated/deactivated or reconfigured. The WTRU may report a PHR on the next transmission occasion after the timer expired.

Various WTRU behaviors based on various aspects of the herein described mechanisms are described below. For example, as the WTRU may measure and report RI (Rank Indicator) in its CSI feedback, for a two MIMO decoders architecture with two radio chains, only when the channel rank goes beyond 4, it is possible for the base station and WTRU to handle two codewords. Thus, the second MIMO decoder nay be kept OFF when channel rank indicator is below 4, and thus power savings may be achievable.

A WTRU may do one or more of the following as part of a procedure for managing uplink (UL) resources and power. A WTRU may report (e.g., send capability information) its capability for support of SRS port-grouping, e.g., G_max>=2. A WTRU may enters CONNECTED_MODE. A WTRU may receive configuration for CSI measurement and report, where the configured CSI report quantity includes RI (rank indication). A WTRU may receive a configuration to support two SRS port-groups identified as, SPGs SPG-ID #1 and SPG-ID #2.

A WTRU may perform CSI measurement based on the configured CSI and SRS port-groups. If the WTRU determines and reports RI<=4, once triggered for SRS transmission for DL CSI estimation, the WTRU may use a default SRS port-group, e.g., port-group identified as SPG-ID #1. For PHR, if triggered, the WTRU may compute and report SRS type 3 PHR for SPG-ID #1.

If the WTRU determines and reports RI>4, that is to support DL transmission of two code words, the WTRU may automatically send an SRS from SPG-ID #2 in the first available occasion, if the periodic SRS from SPG-ID #2 is configured by base station. Upon reception of the RI>4, the WTRU may receive a DCI with aperiodic SRS request for an SRS resource from SPG-ID #2. Upon triggering the SRS transmission from SPG-ID #2, the WTRU may trigger a type 3 PHR for SRS from SPG-ID #2. The WTRU may power on the second MIMO decoder preparing for two code words reception.

A specific indication of two code words transmission WTRU preparation may be sent by base station before the first real scheduled DL two code words MIMO transmission. Upon receiving such indication, the WTRU may power on and prepare/ramp up/warm up the second RF chain and decoders. For example this can be a 1 bit flag in a DCI. Alternatively, the WTRU may prepare for two code words MIMO operation upon transmission of the PHR for the second SPG-ID #2. When the WTRU reports rank <=4, the WTRU may return to a single SRS group, for example SPG-ID #1 as a single code word can be received.

1. A wireless transmit/receive unit (WTRU) comprising a transceiver and a processor, the processor configured to:
send capability information indicating a capability of the WTRU to support sounding reference signal (SRS) port-grouping, wherein a first SRS port-group comprises a first number of SRS ports and a second SRS port-group comprises a second number of SRS ports;
receive configuration information, wherein the configuration information comprises an indication for the WTRU to support uplink (UL) transmission via the first SRS port-group in accordance with the first number of SRS ports and the second SRS port-group in accordance with the second number of SRS ports, wherein the first SRS port-group comprises an association of a first subset of antennas for transmission of the first set of SRS ports and the second SRS port-group comprises an association of a second subset of antennas for transmission of the second set of SRS ports;
transmit, via the transceiver, the first set of SRS ports via the first SRS port-group; and
transmit, via the transceiver, the second set of SRS ports via the second SRS port-group.

2. The WTRU of claim 1, wherein:
the capability information comprises an indication that the WTRU is capable of jointly processing a received signal via all antennas associated with the first SRS port-group and the second SRS port-group;
the capability information comprises an indication that the WTRU is capable of independently processing the received signal via the first subset of antennas associated with the first SRS port-group and independently processing the received signal via the second subset of antennas associated with the second SRS port-group; or
the capability information comprises an indication that the WTRU is capable of jointly processing a received signal via all antennas associated with the first SRS port-group and the second SRS port-group, and that the WTRU is capable of independently processing the received signal via the first subset of antennas associated with the first SRS port-group and independently processing the received signal via the second subset of antennas associated with the second SRS port-group.

3. The WTRU of claim 1, wherein the capability information comprises an indication of a maximum number of SRS port-group supportable by the WTRU.

4. The WTRU of claim 1, wherein:
first downlink (DL) channel state information (CSI) is associated with the first SRS port-group; and
second DL CSI is associated with the second SRS port-group.

5. The WTRU of claim 1, the processor configured to receive, via the transceiver, a downlink (DL) scheduling grant, wherein the DL scheduling grant comprises an indication for the WTRU to support a DL reception via the first subset of antennas associated with first SRS port-group or via the second subset of antennas associated with the second SRS port-group.

6. The WTRU of claim 5, wherein the configuration information comprises a first transmission configuration indicator (TCI) indicative of processing a first codeword via the first subset of antennas associated with the first SRS port-group and a second TCI indicative of processing a second codeword via the second subset of antennas associated with the second SRS port-group.

7. The WTRU of claim 5, the processor configured to:
process a first codeword via the first subset of antennas associated with the first SRS port-group; and
process a second codeword via the second subset of antennas associated the second SRS port-group.

8. The WTRU of claim 5, wherein SRS port grouping is capable of being dynamically activated or deactivated via the DL scheduling grant.

9. The WTRU of claim 1, the processor configured to:
receive a downlink (DL) reference signal for pathloss estimation; and
determine a pathloss associated with the first subset of antennas associated with the first SRS port-group and the second subset of antennas associated with the second SRS port-group.

10. The WTRU of claim 9, the processor configured to:
send, via the transceiver, a first power headroom report (PHR) for the first SRS port-group; and
send, via the transceiver, a second PHR for the second SRS port-group.

11. A method performed by a wireless transmit/receive unit (WTRU), the method comprising:
sending capability information indicating a capability of the WTRU to support sounding reference signal (SRS) port-grouping, wherein a first SRS port-group comprises a first number of SRS ports and a second SRS port-group comprises a second number of SRS ports;
receiving configuration information, wherein the configuration information comprises an indication for the WTRU to support uplink (UL) transmission via the first SRS port-group in accordance with the first number of SRS ports and the second SRS port-group in accordance with the second number of SRS ports, wherein the first SRS port-group comprises an association of a first subset of antennas for transmission of the first SRS ports and the second SRS port-group comprises an association of a second subset of antennas for transmission of the second set of SRS ports;
transmitting the first set of SRS ports via the first SRS port-group; and
transmitting the second set of SRS ports via the second SRS port-group.

12. The method of claim 10, wherein:
the capability information comprises an indication that the WTRU is capable of jointly processing a received signal via all antennas associated with the first SRS port-group and the second SRS port-group;
the capability information comprises an indication that the WTRU is capable of independently processing the received signal via the first subset of antennas associated with the first SRS port-group and independently processing the received signal via the second subset of antennas associated with the second SRS port-group; or
the capability information comprises an indication that the WTRU is capable of jointly processing a received signal via all antennas associated with the first SRS port-group and the second SRS port-group, and that the WTRU is capable of independently processing the received signal via the first subset of antennas associated with the first SRS port-group and independently processing the received signal via the second subset of antennas associated with the second SRS port-group.

13. The method of claim 10, wherein the capability information comprises an indication of a maximum number of SRS port-group supportable by the WTRU.

14. The method of claim 10, wherein:
first downlink (DL) channel state information (CSI) is associated with the first SRS port-group; and
second DL CSI is associated with the second SRS port-group.

15. The method of claim 10, further comprising receiving a downlink (DL) scheduling grant, wherein the DL scheduling grant comprises an indication for the WTRU to support a DL reception via the first subset of antennas associated with first SRS port-group or via the second subset of antennas associated with the second SRS port-group.

16. The method of claim 15, wherein the configuration information comprises a first transmission configuration indicator (TCI) indicative of processing a first codeword via the first subset of antennas associated with the first SRS port-group and a second TCI indicative of processing a second codeword via the second subset of antennas associated with the second SRS port-group.

17. The method of claim 15, further comprising:
processing a first codeword via the first subset of antennas associated with the first SRS port-group; and
processing a second codeword via the second subset of antennas associated the second SRS port-group.

18. The method of claim 15, wherein SRS port grouping is capable of being dynamically activated or deactivated via the DL scheduling grant.

19. The method of claim 10, further comprising:
receiving a downlink (DL) reference signal for pathloss estimation; and
determining a pathloss associated with the first subset of antennas associated with the first SRS port-group and the second subset of antennas associated with the second SRS port-group.

20. The method of claim 19, further comprising:
sending a first power headroom report (PHR) for the first SRS port-group; and
sending a second PHR for the second SRS port-group.
